(19) United States
(12) Patent Application Publication
(10) Pub. No.: US 2008/0254823 A1
(43) Pub. Date: Oct. 16, 2008

(54) Tv Antenna for a Mobile Terminal Device

(76) Inventor: Carl-Gustaf Blom, Lysekil (SE)

Correspondence Address: BACHMAN & LAPOINTE, P.C., 900 CHAPEL STREET, SUITE 1201, NEW HAVEN, CT, 06510, US

(21) Appl. No.: 11/793,506

(22) PCT Filed: Dec. 13, 2005
(86) PCT No.: PCT/SE05/01898

§ 371 Date: Mar. 5, 2008

(30) Foreign Application Priority Data
Dec. 21, 2004 (SE) 0403110-0

(51) Int. Cl. H04M 1/00

(52) U.S. Cl. 455/556.1

(57) ABSTRACT

A mobile telephone has an integrated TV receiver and a TV antenna connected thereto. The mobile telephone has an E-field antenna for receiving radio signals and an H-field antenna for receiving TV signals. The TV antenna is connected to a low noise amplifier which in turn is connected to a switch. The switch is further connected to the TV receiver which has a channel selector. The channel selector has an outlet for control voltage which is intended to control a tuner unit for tuning the resonance frequency of the TV antenna. The TV antenna has a closed loop of metallic conductive material which is magnetically connected to an inner loop. The inner loop is placed interiorly in and in the same plane as the loop. The inner loop is to have an inscribed area which amounts to approximately 10% of the inscribed area of the outer loop.

### BACKGROUND

(1) Field of the Invention

The present invention relates to a mobile terminal device, such as a cell or mobile telephone, and including transmitting and receiving telephony circuits, at least one transmitting and receiving telephony antenna connected to these circuits, a TV receiver and a TV antenna connected thereto.

2. Background Art

Mobile terminal devices, in daily parlance so-called cell or mobile telephones are previously known in the art as being rehearsed for TV reception. In such instance, a TV receiver is integrated in the mobile telephone and employs the display feature of the mobile telephone as its visual display unit. The TV receiver has a separate antenna which is conventionally designed as a telescopic rod antenna of a length of between 20 and 50 cm, hence extremely cumbersome compared with the dimensions of a state-of-the-art mobile telephone.

A rod antenna of the type that has previously been used for receiving TV signals in a mobile telephone has a basic resonance at a given frequency, but also additional resonances at double the frequency, triple the frequency and so on. This implies that the rod antenna will be extremely sensitive to interference when it is employed in an environment with other transmitting antennas nearby, in the case of a mobile telephone at worst only of the order of magnitude of one or a few centimetres' distance away from the transmitting antenna.

The tendency of the rod antenna to be sensitive to interference outside the intended frequency range also implies that the received TV signal contains large quantities of undesirable signals which are normally filtered off in an extra filter in order that the TV image is not unacceptable.

Finally, telescopic rod antennas are prohibitively expensive in manufacture and sensitive to external action and for these reasons alone are less suitable.

### SUMMARY OF THE INVENTION

The present invention has for its object to design the mobile terminal device intimated by way of introduction such that the drawbacks inherent in the prior art are obviated. In particular, the present invention has for its object to design the terminal device so that, for TV reception, it can be given an antenna which, apart from being insensitive to interference, is extremely small in physical dimensions. Further, the present invention has for its object to design the terminal device such that the antenna employed for TV reception may be manufactured economically and simply and be relatively uncritical as regards its positioning in the mobile telephone.

The objects forming the basis of the present invention will be attained if the mobile terminal device according to the invention is characterised in that the telephony antenna is an E-field antenna, while the TV antenna is an H-field antenna.

As a result of these features, the major advantages will be afforded that conventional antennas may be employed for telephony, these operating as E-field antennas and which thereby may readily be designed as multiple band antennas according to thoroughly-tested technology. In addition, the design of the TV antenna as an H-field antenna realises, on the one hand, extremely compact constructional dimensions and, on the other hand, a great degree of selectivity and insensitivity to interference. Further, the positioning of the TV antenna will be less critical than would have been the case if an E-field antenna had also been employed there.

### BRIEF DESCRIPTION OF THE ACCOMPANYING DRAWINGS

The present invention will now be described in greater detail hereinbelow, with reference to the accompanying Drawings. In the accompanying Drawings:

FIG. 1 is a block diagram of a device for TV reception in a mobile telephone;

FIG. 2 shows a first embodiment of an antenna for TV reception included in a mobile telephone;

FIG. 3 is a coupling diagram of a tuner unit included in the antenna according to FIG. 2;

FIG. 4 shows an alternative version of the antenna according to FIG. 2; and

FIG. 5 shows yet a further version of the antenna according to FIG. 2.

### DETAILED DESCRIPTION OF THE PREFERRED EMBODIMENT(S)

The present invention will be described hereinbelow exemplified by means of a mobile telephone. However, the expression “mobile terminal device” set out in the appended Claims is to be given such broad interpretation as to encompass therein any terminal device which in itself includes telephony circuits, for example a laptop with a telephone.

Radio and TV signals consist of electromagnetic fields with orthogonal E-fields and H-fields, where the E-field is a voltage field and the H-field is a magnetic field. Traditionally, E-field antennas have been employed for mobile telephony, int. al. for the reason that the so-called SAR value can normally be lower.

The standard with which the subject matter of the present invention is intended to comply is DVB-H (Digital Video Broadcasting Handheld) which is a digital TV format in the frequency range of between 470 and 702 MHz. However, the present invention may also find application within other digital formats as well as within analogue TV.

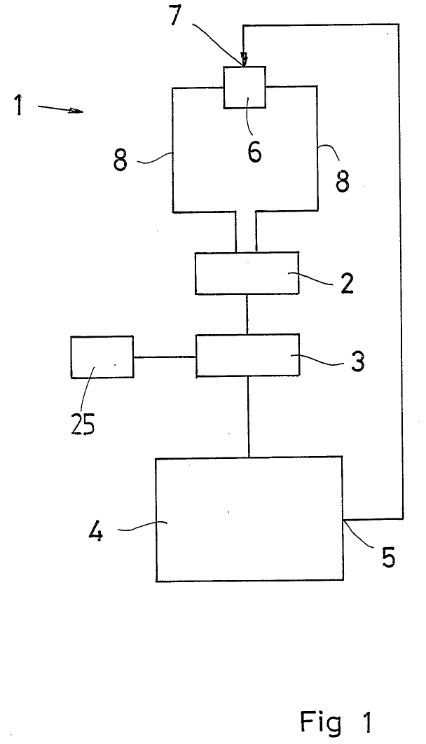

In FIG. 1, reference numeral 1 relates to an antenna device which is intended for TV reception. The antenna device is connected to a low noise amplifier 2 which in turn is connected to a switch 3 whose purpose will be described in greater detail below and which is connected to a TV receiver 4. The TV receiver 4 is provided with a channel selector or a device for frequency adjustment. This channel selector has an output 5 for a control voltage which is intended to control a tuner unit 6 included in the antenna device 1 for setting the resonance frequency of the antenna device 1. The tuner unit has an input 7 for the above-mentioned control voltage.

As has been intimated above, the purpose of the tuner unit 6 is to tune the antenna unit 1 so that it only receives a single, well-defined resonance frequency which is selected so that the resonance frequency corresponds to the central frequency in a special TV channel. Outside this set frequency, the antenna device 1 does not “see” any radiation source for electromagnetic radiation.

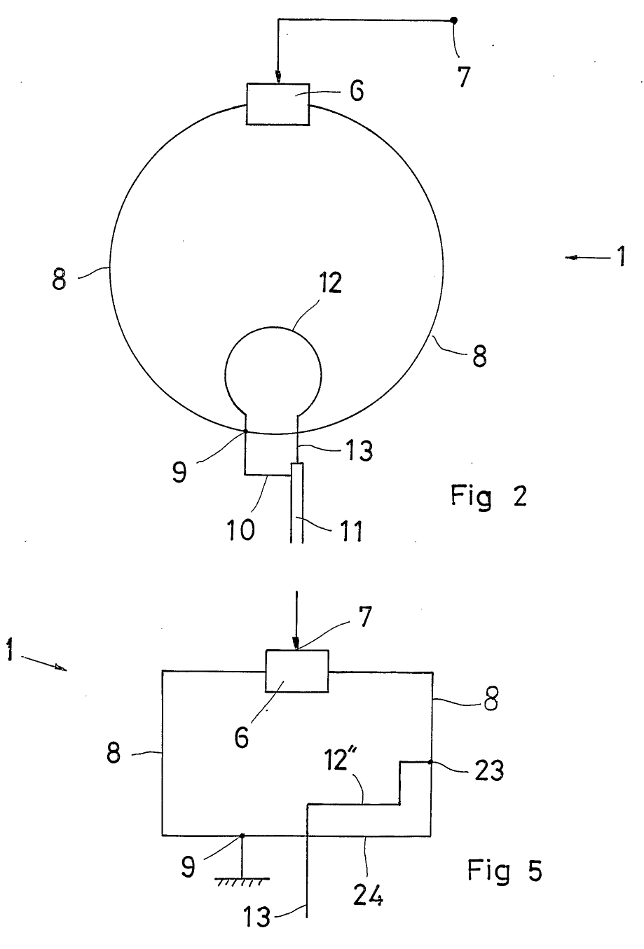

FIG. 2 shows in greater detail a fust embodiment of the antenna device 1. It will be apparent from the Figure that the antenna device has a closed loop 8 which is metallic or produced from other electrically conductive material and in which the tuner unit 6 is connected. In the illustrated embodiment, the closed loop 8 is shown with more circular configuration, but this is not necessary, rather the loop may be given a large number of varying configurations, as long as they have a reasonably large inscribed or enclosed surface in relation to the linear length of the loop.

Approximately diametrically opposite the tuner unit 6, the loop 8 has a grounding point 9 which, in the illustrated embodiment, is connected via a line 10 to the screen in a coaxial cable 11 which in turn is, indirectly or directly (see below), connected to the TV receiver 4 and to ground. In this context, the expression “diametrically opposite” should be interpreted with considerable leeway and may approximately be given the import that the linear length of the loop on either side of the grounding point 9 and up to the tuner unit 6 is to be approximately equal. The expression is also applicable to loops that have oval, triangular, rectangular or polygonal configuration of the loop. It could even be possible to place the turner unit 6 in any position along the outer loop 8. Especially, it may be of interest to place it in the vicinity of the inner loop 12; in FIG. 2 to the right of or to the left of the grounding point 9.

The loop 8 is substantially magnetically connected to an inner loop 12 or connection loop which may have the same general configuration as the outer loop 8.

The inner loop 12 is, as the name suggests, placed interiorly in the outer loop 8 and in the same plane as it and further has its one end connected to the grounding point 9, while its other end is connected to the RF line 13 in the coaxial cable 11.

For that frequency range which is normally employed for DVB-H, in other words between 470 and 702 MHz, the outer loop 8 may have a diameter or a transverse dimension of the order of magnitude of approximately 3 cm. The inner loop 12 is proportionally smaller, approximately as shown in FIG. 2. The inner loop should have an inscribed area which amounts to approximately 10% of the area inscribed by the outer loop 8.

Because of the smaller physical dimensions of the inner loop 12, this may have its own resonance frequency which lies considerably higher than the frequencies within those frequency bands which can be tuned in for the outer loop 8. Thus, the inner loop 12 may be given its own resonance frequency of the order of magnitude of 1 to 3 GHz. At these higher frequencies, the outer loop 8 is inactive. This implies that the inner loop may be tuned to a frequency range which matches together with Bluetooth standard, for which reason the antenna device 1, in addition to the property of being a superior receiver unit for TV, may also be an antenna operating in the frequency range of between 2.4 and 2.5 GHz, for example for a Bluetooth or WLAN application (Wireless Local Area Network).

It is also possible to dimension and/or tune the inner loop 12, so that this could be used for GPS at a frequency of 1575 MHz, or for the L-band in the frequency range of 1670-1675 MHz. The L-band is used in the USA, inter alia for TV-broadcasts according to DVB-H.

FIG. 1 shows, between the low noise amplifier 2 and the TV receiver 4, a switch 3 which is employed if the above-outlined function is to be utilised. Thus, with the switch 3, it is possible to connect in, for example a Bluetooth unit 25 to the antenna device 1.

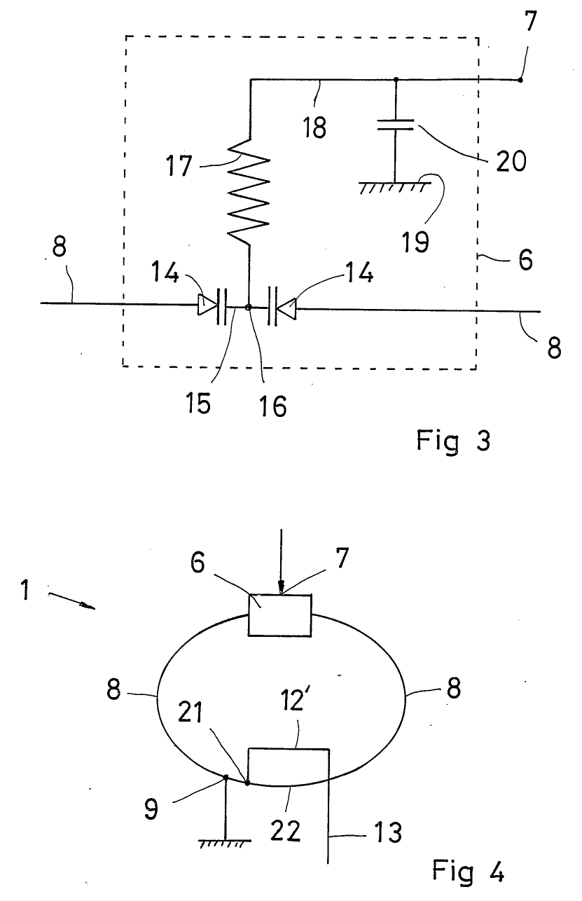

FIG. 3 shows a preferred embodiment of the tuner unit 6 which is included in the antenna device 1 according to the invention. This is marked by the broken line frame 6. It will be apparent from the Figure that the outer loop 8 extends into the tuner unit 6 with its opposite ends, both of these ends each being connected to its varicap diode 14. The two varicap diodes are connected to one another by the intermediary of a line 15 which passes through a connection point 16. An inductance 17 is connected to the connecting point 16 and is, via a line 18, connected to the input 7 of the tuner unit 6 for control voltage from the TV receiver, and further the line 18 is connected to ground 19 via a capacitance 20.

In one practical embodiment, the TV receiver may provide the input 7 with a control voltage approximately in the range of between 0.5 and 3V and where the control voltage is proportional to the pertinent frequency on TV reception. This variable control voltage will cause the varicap diodes 14 to change capacitance so that the antenna device 1 will thereby be tuned to the correct frequency.

In the loop 8, currents are formed on reception which are principally to be conducted to the TV receiver as an input signal thereto. Thus, it is not desirable that current be led off from the antenna device 1 and find its way elsewhere. The currents in the loop 8 are high frequency currents, for which reason the inductance 17 will give rise to extremely large impedance that prevents or at least greatly reduces current leakage through the line 18 to the input 7. High frequency currents possibly passing through the inductance 17 pass via the capacitance 20 to ground 19 so that the output 5 of the TV receiver for control voltage will thereby be protected from high frequency currents.

In FIG. 2, the inner loop 12 may be described as consisting of its own conductor, since, unlike that shown in the Figure, it is possible purely physically to place the grounding point 9 considerably more proximal the RE line 13 in the coaxial cable 11.

In FIG. 4, which shows a modified embodiment of the antenna device 1, the outer loop has been given oval or elliptical configuration. However, this elliptical configuration is not so elongate or narrow that the relationship between the inscribed area of the loop 8 and the linear length of the loop will far too small. The loop 8 could also be sharper edged than that which is apparent from FIG. 4.

In the embodiment according to FIG. 4, the inner loop 12′ is designed in a slightly different manner than that which is apparent from FIG. 2. The inner loop 12′ still consists of a length of RF line 13 which, in one connection point 21, is connected to the loop 8. In this embodiment, the grounding point 9 and the connection point 21 are discrete and separate. In this embodiment, the inner loop 12′ may also be considered as including a conductor section 22 which lies between the connection point 21 and that point where the RF line 13 intersects the outer loop 8. The conductor section 22 will, therefore, serve double functions and constitute, on the one hand, a part of the outer loop 8, but also a part of the inner loop 12′. FIG. 5 shows a further modified embodiment of the antenna device 1 according to the invention. It will be apparent from this Figure that the outer loop 8 in this embodiment has been given a rectangular configuration. It should be emphasised that the relationship between length and width of this rectangle may vary and that the comers of the rectangle may also be more or less rounded.

Like the above-described embodiments, the antenna device in this embodiment has a tuner unit 6 with an input 7 for control voltage and moreover a grounding point 9. It will be apparent from the Figure that the grounding point 9 is not located exactly opposite the tuner unit 6 but is offset somewhat along the one longitudinal side of the outer loop 8. This illustrates that the above-disclosed expression “substantially diametrically opposite” should be given a very broad interpretation.

It will further be apparent from the Figure that the RF line 13 in this embodiment is led off in a direction away from the grounding point 9 and is connected to the outer loop 8 in a connection point 23. In this embodiment, the inner loop 12″ has been given a configuration similar to a L. It will further be apparent that, like the embodiment according to FIG. 4, a conductor section 24 serves double functions in that it constitutes, on the one hand, a part of the outer loop 8, but also a part of the inner loop 12″.

By varying the size and configuration of the inner loop 12, 12′ and 12″, it is possible to impart to the inner loop its own resonance frequency which may be employed with an RF unit operating in the frequency range of from 2 to 3 GHz, for example a Bluetooth unit.

An antenna device 1 of the above-described H-field type is highly selective. This implies that, without the risk of being interfered with, it may be placed close to transmitting antennas in the telephony range. Further, it will be considerably less sensitive to positioning adjacent a ground plane, a battery or any other interfering object than would be an antenna normally used for telephony purposes. The antenna device according to the invention may therefore be placed on an inner shell for a mobile telephone, but also, possibly as a decoration, completely on the outside of an outer shell for the mobile telephone.

Thus, the antenna device 1 may be realised by metallization of plastic details included in the inner or outer shell for a mobile telephone. Metallization of the plastic parts may, for example, be realised by some form of MID (Moulded Interconnect Device) technology. Other production processes may, for example, be IMD (In Mould Decoration) technology or one of the closely related technologies IMF (In Mould Foiling) or IML (In Mould Labelling). These techniques are well-known to a person skilled in the art and entail that the antenna device and also certain parts of the tuner unit may readily be integrated with the plastic part in a casting or moulding process. A further possibility for manufacture resides in the employment of so-called flexfilm which may subsequently be secured on a plastic part or integrated in a conventional circuit card. The antenna device may also be produced as a separate component of metal or conductive plastic.

The low noise amplifier 1 illustrated in FIG. 1 may be wholly or partly integrated with the antenna device 1 according to the invention. However, it may also be integrated with the TV receiver 4. Correspondingly, at least certain parts of the tuner unit 6, but also all of it, may be integrated with the antenna device 1.

1-12. (canceled)

13. A mobile terminal device which comprises transmitting and receiving telephony circuits, at least one transmitting and receiving telephony antenna connected to said circuits, a TV receiver and a TV antenna connected thereto, and the telephony antenna being an E-field antenna, and the TV antenna being an H-field antenna.

14. The mobile terminal device as claimed in claim 13, wherein the E-field antenna is a multiband antenna and the H-field antenna has a tuner unit for frequency-channel selection.

15. The mobile terminal device as claimed in claim 14, wherein the TV receiver has an output for a variable control voltage; and said control voltage is connectable to the tuner unit.

16. The mobile terminal device as claimed in claim 13, further comprising a low noise amplifier electrically connected in between the H-field antenna and the TV receiver.

17. The mobile terminal device as claimed in claim 16, wherein the low noise amplifier is integrated with the H-field antenna.

18. The mobile terminal device as claimed in claim 16, wherein the low noise amplifier is integrated with the TV receiver.

19. The mobile terminal device as claimed in claim 14, wherein at least certain parts of the tuner unit are integrated with the H-field antenna.

20. The mobile terminal device as claimed in claim 14, wherein the tuner unit is integrated with the H-field antenna.

21. The mobile terminal device as claimed in claim 13, wherein in electric terms, it is connected, between the H-field antenna and the TV receiver, via a switch, to an RF unit operating in the frequency band from 2 to 3 GHz.

22. The mobile terminal device as claimed in claim 21, wherein an inner loop included in the H-field antenna is disposed as an antenna to the RF unit.

23. The mobile terminal device as claimed in claim 13, wherein the H-field antenna is disposed on or in an outer casing for the terminal device.

24. The mobile terminal device as claimed in claim 13, wherein the H-field antenna is disposed in an outer casing for the terminal device.

25. The mobile terminal device as claimed in claim 13, wherein the H-field antenna is disposed on or in an inner casing for the terminal device.

26. The mobile terminal device as claimed in claim 13, wherein the H-field antenna is disposed in an inner casing for the terminal device.

27. The mobile terminal device as claimed in claim 13, wherein said mobile terminal device is a mobile telephone.
